(19) United States
(12) Patent Application Publication
(10) Pub. No.: US 2025/0288868 A1
(43) Pub. Date: Sep. 18, 2025

(54) FOOT EXERCISE DEVICE

(71) Applicant: Jiahao WANG, Jiande City (CN)

(72) Inventor: Jiahao WANG, Jiande City (CN)

(21) Appl. No.: 19/227,459

(22) Filed: Jun. 4, 2025

(51) Int. Cl. A63B 23/10; A61H 15/00; A63B 23/08

(52) U.S. Cl. CPC A63B 23/10; A61H 15/00; A61H 2015/0014; A61H 2015/0064; A63B 23/08

(57) ABSTRACT

The present invention discloses a foot exercise device comprising a column, which includes multiple detachable exercise components and exercise tools. The exercise modules are sequentially assembled to form the column and collectively define an internal chamber. The exercise tools are detachably inserted into the internal chamber. When performing foot exercise, the user can carry the foot exercise device to accommodate different exercise tools corresponding to various stages of exercise. The device features a simple structure and is easy to carry, making it a versatile modular solution for different users.

### TECHNICAL FIELD

The present invention relates to sports exercise devices, particularly to a foot exercise device.

### BACKGROUND OF THE INVENTION

A foot exercise device refers to an apparatus designed to enhance the strength and flexibility of the feet, ankles, and surrounding muscles. Such devices are highly beneficial for improving overall foot health, preventing injuries, accelerating the recovery process, and enhancing exercise performance. Common foot exercise devices include massage rods, massage balls, balance devices, and flexible straps. Massage rods are used for rolling massage of the feet to promote muscle recovery and relaxation; massage balls can provide deep tissue massage for the plantar fascia and other soft tissues, which helps relieve tension, increase blood circulation, and reduce pain. By standing or moving on the surface of a balance device, users can enhance ankle stability and improve proprioception. Flexible straps offer different levels of resistance to strengthen the muscles around the toes and ankles, making them suitable for exercises aimed at increasing strength and flexibility.

Current foot exercise devices on the market are typically used and stored individually. When engaging in foot exercise, users need to carry different exercise tools according to their exercise progress. Occasionally, users may forget to bring a particular exercise device, thereby failing to achieve their exercise objectives, especially when multiple exercise sessions are scheduled within a single day. For users who require a variety of foot exercises, carrying and managing multiple separate exercise devices can be inconvenient. Therefore, a modular device that can meet diverse foot exercise needs is essential.

To address the above issues, the present invention provides a foot exercise device that features a simple structure and is easy to carry.

### SUMMARY OF THE INVENTION

To address the shortcomings of the prior art, the present invention provides a foot exercise device that is simple in structure and easy to carry.

The technical solution adopted by the present invention to solve the technical problem is as follows:

A foot exercise device, comprising:

A column, which includes multiple detachable exercise components and exercise tools, wherein the exercise components are sequentially assembled to form the column, and the exercise components collectively define an internal chamber; the exercise tools are detachably inserted into the internal chamber.

As an improvement of the present invention, the device further comprises a flexible strap that is movably fitted around the column to restrict movement of the exercise components.

As an improvement of the present invention, along the central axis of the internal chamber, at least one inner wall defining the internal chamber extends outward until the internal chamber is in communication with the external environment.

As an improvement of the present invention, in a direction perpendicular to the central axis of the internal chamber, at least one inner wall defining the internal chamber extends outward until the internal chamber is in communication with the external environment.

As an improvement of the present invention, the exercise component includes a first support surface, which is an inner wall surface defining the internal chamber, and the first support surface is configured to contact a support plane.

As an improvement of the present invention, the first support surface is equal in length to the column along the central axis of the internal chamber.

As an improvement of the present invention, the exercise component includes a second support surface and a third support surface, which are configured to contact a support plane.

As an improvement of the present invention, the second support surface and the third support surface are equal in length to the column along the central axis of the internal chamber.

As an improvement of the present invention, the second support surface and the third support surface are located on opposite sides of the symmetry axis of the exercise component.

As an improvement of the present invention, the central axis of the internal chamber is coaxial with the central axis of the column.

As an improvement of the present invention, the exercise tools include a massage ball and/or a massage rod.

As an improvement of the present invention, the outer contour of the massage ball and/or the massage rod matches the inner wall surface defining the internal chamber.

As an improvement of the present invention, the diameter of the massage ball is smaller than the diameter of the internal chamber.

As an improvement of the present invention, the diameter of the massage rod is smaller than the diameter of the internal chamber.

As an improvement of the present invention, there are multiple internal chambers, and the massage ball and/or the massage rod are located in different internal chambers.

As an improvement of the present invention, the flexible strap is detachably inserted into the internal chamber.

As an improvement of the present invention, the flexible strap is movably fitted around the column in a ring shape to restrict movement of the exercise components.

As an improvement of the present invention, the flexible strap is movably fitted around the column in a longitudinal direction to restrict movement of the exercise components.

As an improvement of the present invention, the device further comprises a binding strap that is movably fitted around the column to move the column.

As an improvement of the present invention, the column is made of cork.

The present invention provides the following advantages: By virtue of the above structure, the foot exercise device is composed of multiple independent exercise components that collectively define an internal chamber. The internal chamber can accommodate different exercise tools as required by the user. When engaging in foot exercise, users can carry this foot exercise device to meet the varying exercise needs at different stages of progress. The device features a simple structure and is easy to carry, making it a versatile modular solution that can satisfy the diverse foot exercise needs of different users.

### BRIEF DESCRIPTION OF DRAWINGS

In order to more clearly illustrate the technical solutions of the embodiments of the present invention, brief descriptions of the accompanying drawings required in the description of the embodiments are provided below. The accompanying drawings described herein are merely exemplary illustrations of certain embodiments of the present invention. It should be understood by those skilled in the art that other drawings may also be derived from these examples without the need for inventive effort.

The following is a further explanation of the present invention in conjunction with the drawings and embodiments.

FIG. 1 is a schematic diagram of the overall structure of the first embodiment of the foot exercise device of the present invention;

FIG. 2 is a sectional view of the first embodiment of the foot exercise device of the present invention;

FIG. 3 is a schematic diagram of the exercise components of the first embodiment of the foot exercise device of the present invention;

FIG. 4 is a schematic diagram of the overall structure of the second embodiment of the foot exercise device of the present invention;

FIG. 5 is a sectional view of the second embodiment of the foot exercise device of the present invention;

FIG. 6 is a schematic diagram of the exercise components of the second embodiment of the foot exercise device of the present invention;

FIG. 7 is an exploded view of the third embodiment of the foot exercise device of the present invention;

FIG. 8 is a sectional view of the third embodiment of the foot exercise device of the present invention;

FIG. 9 is a schematic diagram of the exercise component of the third embodiment of the foot exercise device of the present invention;

FIG. 10 is a schematic diagram of the overall structure of the fourth embodiment of the foot exercise device of the present invention;

FIG. 11 is an exploded view of the fifth embodiment of the foot exercise device of the present invention;

FIG. 12 is a sectional view of the fourth embodiment of the foot exercise device of the present invention;

FIG. 13 is a schematic diagram of the exercise components of the fourth embodiment of the foot exercise device of the present invention;

FIG. 14 is a schematic diagram of the overall structure of the fifth embodiment of the foot exercise device of the present invention;

FIG. 15 is another schematic diagram of the overall structure of the fifth embodiment of the foot exercise device of the present invention;

FIG. 16 is a schematic diagram of the exercise components of the fifth embodiment of the foot exercise device of the present invention;

FIG. 17 is a sectional view of the sixth embodiment of the foot exercise device of the present invention;

FIG. 18 is an exploded view of the seventh embodiment of the foot exercise device of the present invention;

FIG. 19 is a schematic diagram of the exercise tool of the foot exercise device of the present invention.

Reference numerals: 1, column; 10, exercise components; 20, internal chamber; 30, exercise tools; 11, first support surface; 12, second support surface; 13, third support surface; 31, massage ball; 32, massage rod; 33, flexible strap.

### DETAILED DESCRIPTION OF THE INVENTION

To make the objectives, features, and advantages of the present application clearer and more comprehensible, the specific embodiments of the present application are described in detail below in conjunction with the accompanying drawings. Many specific details are set forth in the following description to fully understand the present application. However, the present application can be implemented in many different ways other than those described herein. Those skilled in the art can make similar improvements without departing from the spirit of the present application. Therefore, the present application is not limited to the specific embodiments disclosed below.

In the description of the present application, it should be understood that if terms such as “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc., appear, these terms indicate directions or positional relationships based on the directions or positional relationships shown in the accompanying drawings. They are used only for the convenience of describing the present application and simplifying the description, rather than indicating or implying that the device or element must have a specific orientation, be constructed and operated in a specific orientation, and therefore should not be construed as a limitation on the present application.

In addition, if terms such as “first” and “second” appear, these terms are used for descriptive purposes only and should not be construed as indicating or implying relative importance or implying the number of the technical features indicated. Therefore, features defined by “first” and “second” may explicitly or implicitly include at least one such feature. In the description of the present application, if the term “multiple” appears, the meaning of “multiple” is at least two, such as two, three, etc., unless otherwise specifically limited.

In the present application, unless otherwise expressly provided and defined, if terms such as “installed,” “connected,” “coupled,” “fixed,” etc., appear, these terms should be understood broadly. For example, they may refer to fixed connections, detachable connections, or integral formations; they may be mechanical connections or electrical connections; they may be direct connections or indirect connections through intermediate media, or they may refer to the interconnection or interaction between two components, unless otherwise specifically limited. For ordinary skilled persons in the art, the specific meanings of the above terms in the present application can be understood according to specific situations.

In the present application, unless otherwise expressly provided and defined, if it is described that a first feature is “above” or “below” a second feature, it means that the first and second features may be in direct contact, or they may be in indirect contact through an intermediate medium. Moreover, “above,” “on top of,” and “over” may mean that the first feature is directly above or diagonally above the second feature, or it may simply indicate that the first feature is at a higher horizontal level than the second feature. Similarly, “below,” “underneath,” and “beneath” may mean that the first feature is directly below or diagonally below the second feature, or it may simply indicate that the first feature is at a lower horizontal level than the second feature.

It should be noted that if an element is referred to as being “fixed on” or “disposed on” another element, it may be directly on the other element or there may be an intermediate element therebetween. If an element is referred to as being “connected to” another element, it may be directly connected to the other element or there may be an intermediate element therebetween. The terms “vertical,” “horizontal,” “upper,” “lower,” “left,” “right,” and similar expressions used in the present application are for illustrative purposes only and do not represent the only possible implementations.

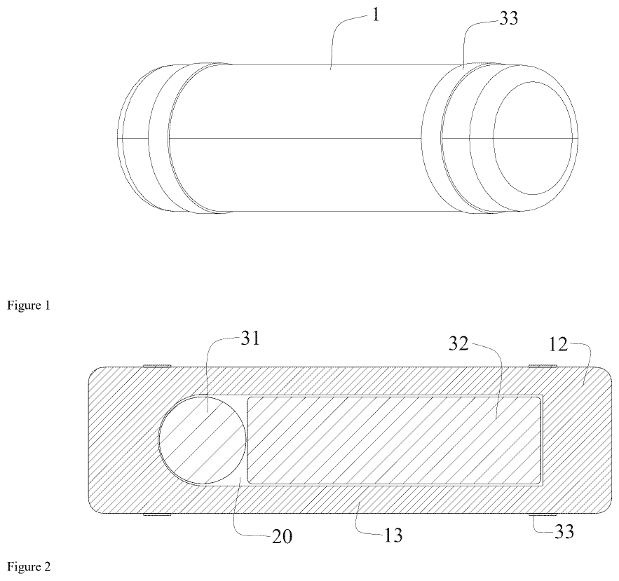

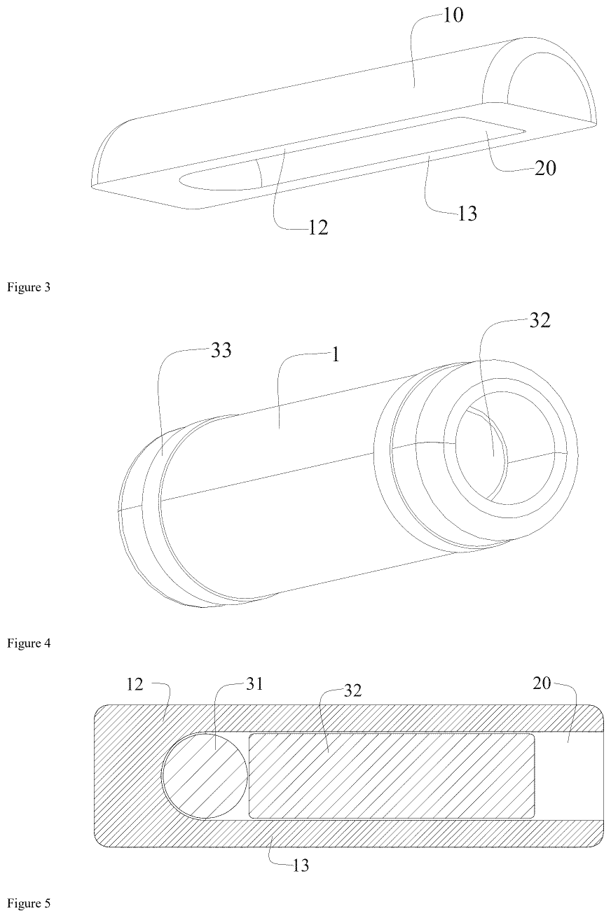

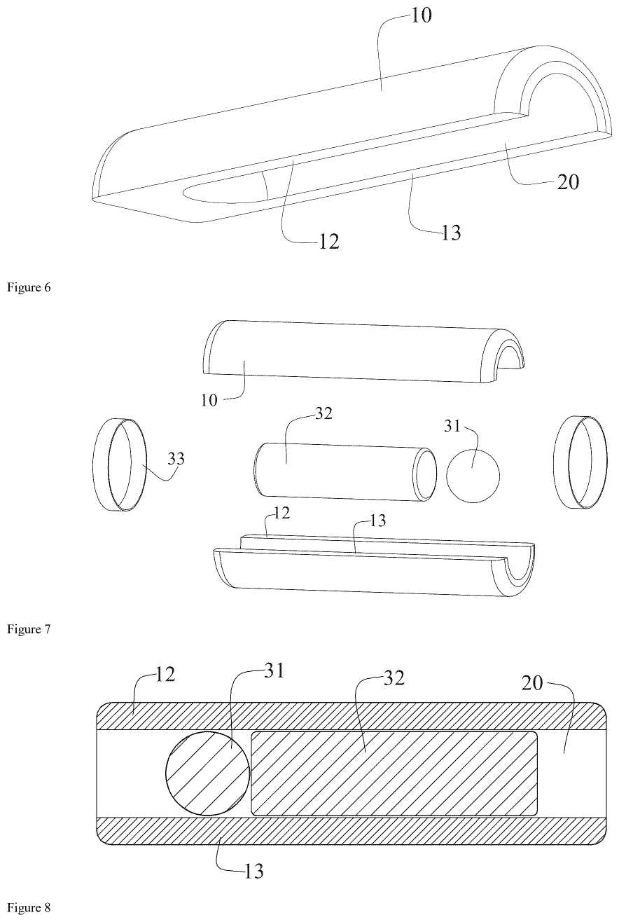

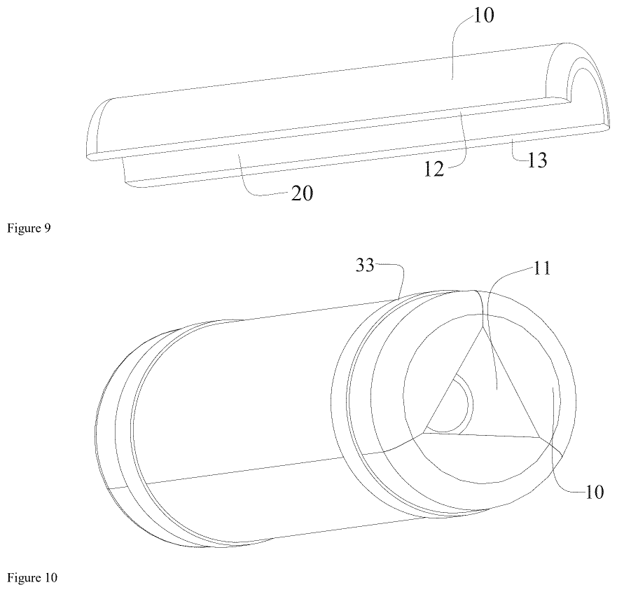

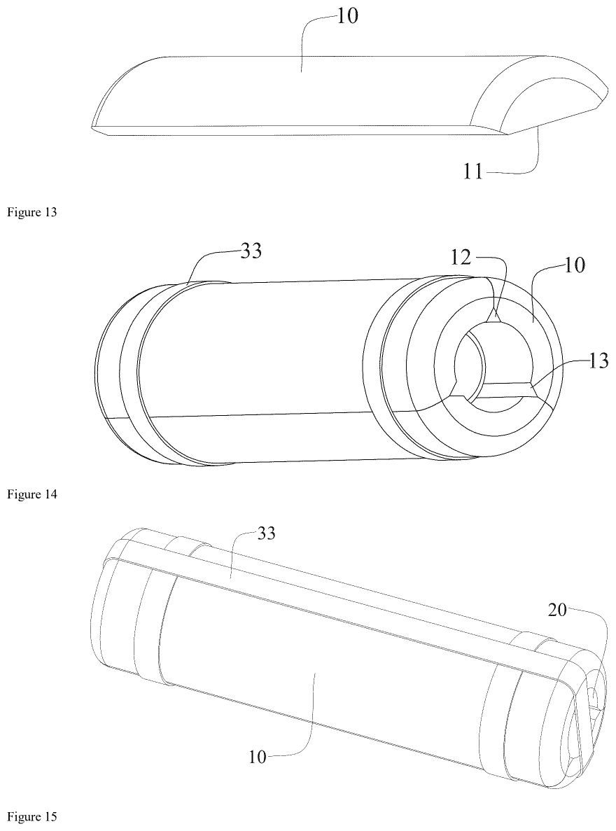

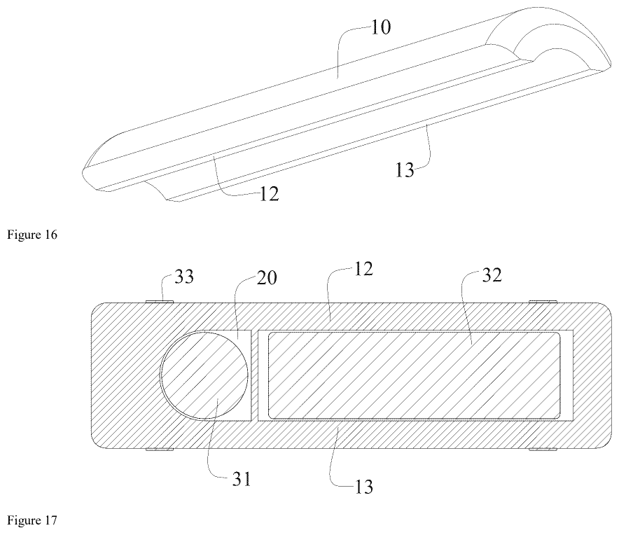

Referring to FIGS. 1 to 17, a foot exercise device includes:

A column 1, which includes multiple detachable exercise components 10 and exercise tools 30, wherein the multiple exercise components 10 are sequentially assembled to form the column 1, and the multiple exercise components 10 collectively define an internal chamber 20; the exercise tools 30 are detachably inserted into the internal chamber 20.

By virtue of the above structure, the foot exercise device is composed of multiple independent exercise components 10 that form a column 1. The multiple exercise components 10 collectively define an internal chamber 20, which can accommodate different exercise tools 30 as required by the user. When engaging in foot exercise, users can carry this foot exercise device to meet the varying training needs at different stages of progress. The device is characterized by its simple structure and portability, making it a versatile modular solution that can satisfy the diverse foot exercise needs of different users. Optionally, the internal chamber 20 can be aligned in the same direction as the central axis of the column 1, or it can be perpendicular to the central axis of the column 1. Additionally, the internal chamber 20 can also be arranged both parallel and perpendicular to the central axis of the column 1. When the column 1 is a right prism, its central axis is the line connecting the centers of the two opposite bases; when the column 1 is an oblique prism, the central axis is determined based on the shape of the base and the angle of inclination.

In this embodiment, the column 1 is cylindrical and is composed of two detachable exercise components 10. As shown in FIGS. 1 to 9, the two detachable exercise components 10 are roughly semi-cylindrical in shape. When combined, they form a cylindrical column 1 and define an internal chamber 20, which can accommodate exercise tools 30, such as a massage rod 32 and a massage ball 31.

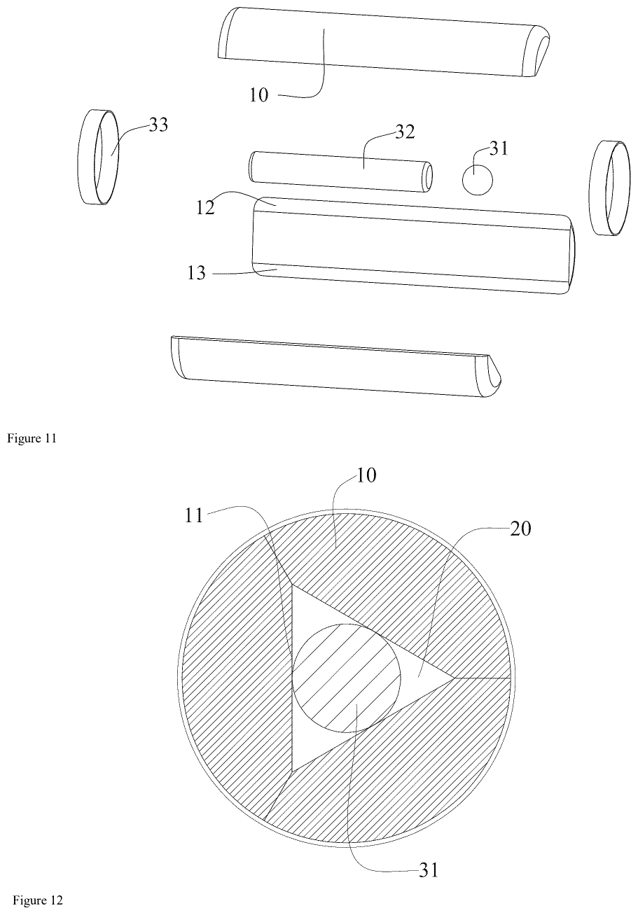

In another embodiment, the column 1 is cylindrical and is composed of three detachable exercise components 10. As shown in FIGS. 10 to 16, the three detachable exercise components 10 are roughly semi-cylindrical in shape. When combined, they form a cylindrical column 1 and define an internal chamber 20, which can accommodate exercise tools 30, such as a massage rod 32 and a massage ball 31.

Optionally, the column 1 can also be configured as a triangular prism, quadrangular prism, pentagonal prism, hexagonal prism, rugby ball shape, etc. The number of exercise components 10 can be determined based on the shape of the column 1. Optionally, the shapes of the multiple exercise components 10 can be the same or different.

In this embodiment, the device also includes a flexible strap 33, which is movably fitted around the column 1 to restrict movement of the multiple exercise components 10. As a training device, the flexible strap 33 is elastic and can be wrapped around the user's toes. By exerting force with the foot to pull the flexible strap 33, the user can enhance toe grip strength and foot muscle strength. A longer flexible strap 33 can also be used for stretching the ankle, knee, and even the arm. Moreover, the elastic flexible strap 33 not only enhances toe grip strength and foot muscle strength but also serves to secure the multiple exercise components 10 into the column 1, as shown in FIGS. 1, 4, 7, 10, and 14. The flexible strap 33 can be fitted around the column 1 in a ring shape to secure the multiple exercise components 10 together, facilitating portability for the user and increasing the versatility and flexibility of foot exercise. This feature is particularly important when the user needs to store or combine different foot exercise tools 30. As shown in FIG. 15, when the internal chamber 20 is a semi-through or fully-through structure, the flexible strap 33 can be fitted around the column 1 in a longitudinal direction. This design prevents the exercise tools 30 stored in the internal chamber 20 from slipping out.

In this embodiment, along the central axis of the internal chamber 20, at least one inner wall defining the internal chamber 20 extends outward until the internal chamber 20 is in communication with the external environment. By virtue of the above structure, at least one inner wall surface defining the internal chamber 20 can extend outward along the central axis of the internal chamber 20 until the internal chamber 20 is in communication with the external environment. The internal chamber 20 is generally cylindrical in shape and is adapted to the shape of the exercise tool 30. This design allows for the adjustment of the volume of the internal chamber 20, enabling users to store the required exercise tools 30 according to different needs. Optionally, as shown in FIG. 2, the inner wall surface defining the internal chamber 20 does not extend outward along the central axis, and in this case, the internal chamber 20 is a non-through structure. Optionally, as shown in FIG. 5, one of the inner wall surfaces defining the internal chamber 20 extends outward along the central axis, and in this case, the internal chamber 20 is a semi-through structure, with only one end of the internal chamber 20 in communication with the external environment. Optionally, as shown in FIG. 8, both ends of the inner wall surfaces defining the internal chamber 20 extend outward along the central axis, and in this case, the internal chamber 20 is a fully-through structure, with both ends of the internal chamber 20 in communication with the external environment.

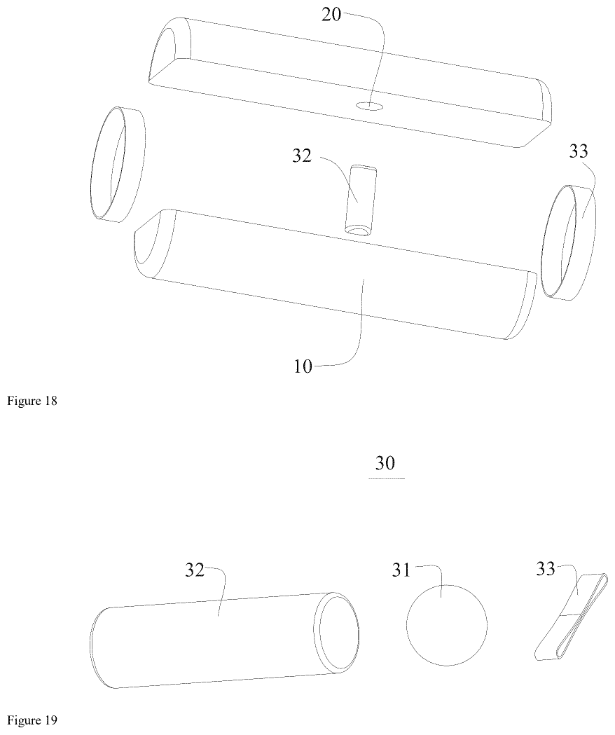

In this embodiment, in a direction perpendicular to the central axis of the internal chamber 20, at least one inner wall defining the internal chamber 20 extends outward until the internal chamber 20 is in communication with the external environment. As shown in FIG. 18, the figure illustrates an internal chamber 20 that extends perpendicularly to the central axis. In this case, the internal chamber 20 can be used to store small exercise tools 30. Accordingly, in a direction perpendicular to the central axis of the internal chamber 20, the inner wall extends outward to form an opening in communication with the external environment. This design allows users to easily access small exercise tools 30 from the opening of the internal chamber 20, such as small nubs or massage rollers. In this case, a wider flexible strap 33 is required to cover the opening of the internal chamber 20 to prevent the exercise tools 30 from falling out.

In this embodiment, the exercise component 10 includes a first support surface 11, which is an inner wall surface defining the internal chamber 20, and the first support surface 11 is configured to contact a support plane. As shown in FIGS. 10 to 13, by virtue of the above structure, the exercise component 10 is supported on a support plane via the first support surface 11. In this case, the user can use the exercise component 10 as a tool for balance training. The user can stand on the exercise component 10 with their heel, forefoot, or the entire sole for different balance training exercises. Different training methods achieve different training effects. Standing on the exercise component 10 with the heel focuses on strengthening the ankle and calf muscles, which helps to improve strength and flexibility in these areas. Standing on the exercise component 10 with the forefoot emphasizes the strengthening of the forefoot, toes, and associated calf muscles, which is particularly effective for improving gait and increasing the strength of the foot muscles. Standing on the exercise component 10 with the entire sole allows for the simultaneous training of the entire foot and associated ankle muscles, which helps to comprehensively improve foot health and balance ability.

In this embodiment, the first support surface 11 is equal in length to the column 1 along the central axis of the internal chamber 20. As shown in FIGS. 10 to 13, by virtue of the above structure, the first support surface 11 is equal in length to the column 1 along the central axis of the internal chamber 20. By increasing the contact area between the first support surface 11 and the support plane, the exercise component 10 can be more securely supported on the support plane. This effectively prevents the device from slipping or toppling during training and meets the training needs of users with a larger body weight.

In this embodiment, the exercise component 10 includes a second support surface 12 and a third support surface 13, which are configured to contact a support plane. As shown in FIGS. 1 to 9 and FIGS. 14 to 16, the exercise component 10 relies on the second support surface 12 and the third support surface 13 to contact the support plane. In FIGS. 1 to 9, the second support surface 12 and the third support surface 13 are the contact surfaces between adjacent exercise components 10. In FIGS. 14 to 16, the internal chamber 20 near the contact surfaces of adjacent exercise components 10 has a cavity with a triangular prism-like structure, and the inner wall surfaces defining this cavity are the second support surface 12 and the third support surface 13. This design, by increasing the contact points between the exercise component 10 and the support plane, significantly enhances the stability of the exercise component 10, making it more suitable for various types of balance training and other foot exercises. Compared to FIG. 10, where the first support surface 11 is used to contact the support plane, FIG. 14 uses the second support surface 12 and the third support surface 13 to contact the support plane, resulting in a different volume of the internal chamber 20. In this case, the internal chamber 20 can accommodate different types of exercise tools 30, allowing users to select the appropriate exercise components 10 based on the required exercise tools 30. The diversified design meets a variety of usage needs.

In this embodiment, the second support surface 12 and the third support surface 13 are equal in length to the column 1 along the central axis of the internal chamber 20. As shown in FIGS. 1 to 9 and FIGS. 14 to 16, this design ensures that the exercise component 10 can be more securely attached to the support plane, increasing the contact area between the exercise component 10 and the support plane, as well as the usable area for the user.

In this embodiment, the second support surface 12 and the third support surface 13 are located on opposite sides of the symmetry axis of the exercise component 10. As shown in FIGS. 1 to 9 and FIGS. 14 to 16, this symmetrical design helps achieve a more balanced weight distribution when the user stands on the exercise component 10, making the exercise component 10 more stable during use and reducing the likelihood of tipping over. This provides a more reliable base for the user, enhancing the safety and user experience of the device.

In this embodiment, the central axis of the internal chamber 20 is coaxial with the central axis of the column 1. As shown in FIGS. 1 to 16, this design ensures that the height of the exercise components 10 when contacting the support plane is consistent. If necessary, users can stand on two exercise components 10 simultaneously for balance training. Additionally, this design allows for multiple users to use the exercise components 10 together. Optionally, when the transverse diameter of the column 1 remains constant, the different transverse diameters of the internal chamber 20 will determine the height of the exercise components 10 when they contact the support plane. Users can select different devices based on their needs and training progress. As a tool for balance training, the exercise components 10 can not only be used for balance training but also for stretching the ankle or leg ligaments and training specific areas by utilizing the height difference between the exercise components 10 and the support plane. When the column 1 is cylindrical or rugby ball-shaped, the column 1 can be used as an integrated training tool, which can roll on the support plane. Users can perform balance, stretching, and other exercises using the column 1.

In this embodiment, the exercise tools 30 include a massage ball 31 and/or a massage rod 32. By virtue of the above structure, at least one of the massage ball 31 and the massage rod 32 can be located in the internal chamber 20, which is used to store the exercise tools 30. In addition to serving as a foot exercise tool itself, the exercise component 10 also provides a storage function. Storing the exercise tools 30 in the internal chamber 20 reduces the space occupied by the exercise tools 30 themselves, making it convenient for users to carry. Users only need to carry the column 1 to meet a variety of foot exercise needs. Users can stimulate the reflex zones of the soles of their feet by rolling the massage ball 31 with their feet, promoting blood circulation and reducing fatigue. Similarly, users can roll the massage rod 32 under their feet to provide targeted deep tissue massage to specific areas of the sole, helping to relieve tension and pain. The diverse exercise tools 30 can meet the different training needs of different users. Optionally, in addition to the two tools mentioned above, any exercise tools 30 that can be placed in the internal chamber 20 can be carried together by the user.

In this embodiment, the outer contour of the massage ball 31 and/or the massage rod 32 matches the inner wall surface of the internal chamber 20. As shown in FIGS. 2 and 5, when at least one inner wall surface defining the internal chamber 20 is spherical, the shape of the internal chamber 20 can be adapted to fit the massage ball 31, ensuring that the massage ball 31 can be securely placed inside. This design allows for better utilization of the storage space within the internal chamber 20, avoiding waste of space. Additionally, the internal chamber 20 can be adjusted to different shapes according to the needs of different users. If only multiple massage balls 31 need to be stored, all the inner wall surfaces defining the internal chamber 20 should be designed as spherical to enhance the compatibility with the massage balls 31. Furthermore, when storing the massage rod 32, the shape of the internal chamber 20 should be adapted according to the shape of the massage rod 32. This design means that the foot exercise device can flexibly accommodate different types of foot exercise tools 30, enhancing its practicality and multifunctionality.

In this embodiment, the diameter of the massage ball 31 is smaller than the diameter of the internal chamber 20. Due to the smaller diameter of the massage ball 31 compared to the internal chamber 20, the massage ball 31 can be easily inserted into or removed from the internal chamber 20, enhancing the convenience of using the massage ball 31. This size difference allows users to place different sizes or types of massage balls 31 in the internal chamber 20 as needed, increasing the flexibility of the device. If the diameter of the massage ball 31 were too large, it would be difficult to insert or remove it from the internal chamber 20, and it might even get stuck or damage the exercise component 10. The smaller diameter ensures smooth operation for the user and reduces the risk of wear and tear on the exercise component 10 and the massage ball 31.

In this embodiment, the diameter of the massage rod 32 is smaller than the diameter of the internal chamber 20. If the diameter of the massage rod 32 were too large, it might be difficult to insert it into the internal chamber 20 or remove it, and it could even cause damage to the column 1 and the massage rod 32, leading to functional failure. The design of the diameter difference ensures that the user can easily access the massage rod 32 and reduces the risk of wear and tear on the entire device. At the same time, the appropriate diameter difference ensures the stability of the massage rod 32 within the internal chamber 20. During transportation of the entire device, it also prevents the massage rod 32 from shaking and rubbing against the exercise components 10, which could cause wear and tear on the exercise components 10.

In this embodiment, the internal chamber 20 is provided in multiple quantities, and the massage ball 31 and/or the massage rod 32 are located in different internal chambers 20. With the above structure, when there are multiple internal chambers 20, the exercise components 10 themselves are used to partition different internal chambers 20, allowing for the separate storage of exercise tools 30 of different shapes. When in use, users only need to take out the corresponding exercise tools 30 from the specific internal chamber 20. This design helps users quickly locate the required exercise tools 30 before use and also helps maintain the cleanliness and orderliness of the exercise tools 30. Moreover, storing different types or sizes of exercise tools 30 separately can prevent damage caused by mutual collisions between them and also reduce the possibility of confusion. As shown in FIG. 17, when the number of internal chambers 20 is 2, the massage ball 31 and the massage rod 32 can be located in different internal chambers 20 respectively.

In this embodiment, the flexible strap 33 is detachably inserted into the internal chamber 20. With the above structure, if a user carries multiple flexible straps 33, the extra flexible straps 33 can be placed in the internal chamber 20 to achieve a neat and orderly carrying method, avoiding the risk of additional space occupation or loss of the flexible straps 33.

In this embodiment, the flexible strap 33 is movably fitted around the column 1 in a ring shape to restrict the movement of the multiple exercise components 10. As shown in FIG. 1, when the internal chamber 20 is a non-through structure, the internal chamber 20 is not in communication with the external environment. At this time, it is only necessary to fit the flexible strap 33 around the column 1 in a ring shape to ensure that the multiple exercise components 10 are tightly and firmly connected. Under this structure, the main function of the flexible strap 33 is to restrict the relative displacement between the multiple exercise components 10, ensuring that the connections between the multiple exercise components 10 are tight and stable, thereby enhancing the overall integrity and stability of the entire device, especially to prevent the exercise components 10 from loosening or shifting during movement of the device by the user.

In this embodiment, the flexible strap 33 is movably fitted around the column 1 in a longitudinal direction to restrict the movement of the multiple exercise components 10. As shown in FIG. 15, when the internal chamber 20 is a semi-through structure or a fully-through structure, the internal chamber 20 is directly in communication with the external environment to form an opening. The exercise tools 30 inserted into the internal chamber 20 may slide out of the opening of the internal chamber 20. To prevent the exercise tools 30 from sliding out, the flexible strap 33 is fitted around the column 1 in a longitudinal direction. This setting is to use the flexible strap 33 to close the opening of the internal chamber 20. The flexible strap 33 should be fitted around the column 1 in a longitudinal direction and positioned in the middle of the opening of the internal chamber 20 to maximize the closure of the opening and prevent the exercise tools 30 from sliding out. When a user needs to store the entire device, the multiple exercise components 10 are sequentially assembled to form the column 1, and then a shorter flexible strap 33 is fitted around the column 1 in a ring shape to connect and fix the multiple exercise components 10. At this time, the exercise tools 30 are placed in the internal chamber 20 through the opening of the internal chamber 20. Finally, a longer flexible strap 33 is fitted around the column 1 in a longitudinal direction to prevent the exercise tools 30 from sliding out of the internal chamber 20. At this point, the entire device is neatly stored after completing the above operations.

In this embodiment, the device also includes a binding strap, which is movably fitted around the column 1 to facilitate the movement of the column 1. Given that the binding strap itself is non-elastic, its primary function is to provide users with a convenient means of carrying or moving the entire device. By fitting the binding strap around the column 1, users can easily transport the device, thereby enhancing its portability. The non-elastic nature of the binding strap offers a reliable grip, allowing users to securely bundle the exercise components 10 together for easy carrying and movement. It is important to note that in various through-structure configurations, the binding strap must properly secure the exercise components 10. Preferably, the binding strap is a woven strap of a certain width to increase the contact area with the user's palm, thereby improving grip comfort. Additionally, its surface may feature anti-slip textures or coatings to enhance friction during bundling and prevent slippage between the exercise components 10. The binding strap can be used in conjunction with the flexible strap 33 to ensure tight connections between the exercise components 10. However, due to the elastic nature of the flexible strap 33, it is not suitable for users to grip and move the entire device. In such cases, the binding strap can be used to move the device.

In this embodiment, the column 1 is made of cork. Given the material properties of cork, its surface provides a certain degree of friction, which helps prevent the user's foot from slipping on the device, thereby enhancing user safety. Additionally, cork's natural cushioning properties effectively absorb impact forces. When users choose cork as the material for foot exercise devices, it can reduce the pressure on joints during training and minimize the risk of injury. Despite its lightweight nature, cork is also robust and durable, meaning that foot exercise devices made of cork are easy to carry and can withstand prolonged use without easily getting damaged. The excellent physical properties of cork make it a preferred material for this device. The above description provides one or more specific embodiments in conjunction with the detailed content. It is not intended to limit the specific implementation of the present invention to these descriptions. Any modifications, adaptations, or substitutions that are similar or equivalent to the methods and structures of the present invention, or that are derived from the inventive concept of the present invention, should be considered within the scope of protection of the present invention.

1. A foot exercise device, characterized in that it comprises:
a column (1), which includes multiple detachable exercise components (10) and exercise tools (30), wherein the exercise components (10) are sequentially assembled to form the column (1), and the exercise components (10) collectively define an internal chamber (20); the exercise tools (30) are detachably inserted into the internal chamber (20).

2. The foot exercise device of claim 1, further comprising a flexible strap (33) that is movably fitted around the column (1) to restrict movement of the exercise components (10).

3. The foot exercise device of claim 1, wherein, along the central axis of the internal chamber (20), at least one inner wall defining the internal chamber (20) extends outward until the internal chamber (20) is in communication with the external environment.

4. The foot exercise device of claim 1, wherein, in a direction perpendicular to the central axis of the internal chamber (20), at least one inner wall defining the internal chamber (20) extends outward until the internal chamber (20) is in communication with the external environment.

5. The foot exercise device of claim 1, wherein each exercise component (10) includes a first support surface (11), which is an inner wall surface defining the internal chamber (20), and the first support surface (11) is configured to abut against a support plane.

6. The foot exercise device of claim 4, wherein the first support surface (11) is equal in length to the column (1) along the central axis of the internal chamber (20).

7. The foot exercise device of claim 1, wherein each exercise component (10) includes a second support surface (12) and a third support surface (13), which are configured to abut against a support plane.

8. The foot exercise device of claim 7, wherein the second support surface (12) and the third support surface (13) are equal in length to the column (1) along the central axis of the internal chamber (20).

9. The foot exercise device of claim 7, wherein the second support surface (12) and the third support surface (13) are located on opposite sides of the symmetry axis of the exercise component (10).

10. The foot exercise device of claim 1, wherein the central axis of the internal chamber (20) is coaxial with the central axis of the column (1).

11. The foot exercise device of claim 1, wherein the exercise tools (30) include a massage ball (31) and/or a massage rod (32).

12. The foot exercise device of claim 11, wherein the outer contour of the massage ball (31) and/or the massage rod (32) matches the inner wall surface defining the internal chamber (20).

13. The foot exercise device of claim 11, wherein the diameter of the massage ball (31) is smaller than the diameter of the internal chamber (20).

14. The foot exercise device of claim 11, wherein the diameter of the massage rod (32) is smaller than the diameter of the internal chamber (20).

15. The foot exercise device of claim 11, wherein there are multiple internal chambers (20), and the massage ball (31) and/or the massage rod (32) are located in different internal chambers (20).

16. The foot exercise device of claim 2, wherein the flexible strap (33) is detachably inserted into the internal chamber (20).

17. The foot exercise device of claim 2, wherein the flexible strap (33) is movably fitted around the column (1) in a ring shape to restrict movement of the exercise components (10).

18. The foot exercise device of claim 2, wherein the flexible strap (33) is movably fitted around the column (1) in a longitudinal direction to restrict movement of the exercise components (10).

19. The foot exercise device of claim 1, further comprising a binding strap that is movably fitted around the column (1) to move the column (1).

20. The foot exercise device of claim 1, wherein the column (1) is made of cork.
